(19) United States
(12) Patent Application Publication
(10) Pub. No.: US 2025/0018538 A1
(43) Pub. Date: Jan. 16, 2025

(54) CLAMPING DEVICE

(71) Applicant: EVERMORE INTERNATIONAL GROUP CO., LTD., George Hill (AI)

(72) Inventor: Wade CHI, Taipei City (TW)

(21) Appl. No.: 18/220,995

(22) Filed: Jul. 12, 2023

(51) Int. Cl. B25B 5/10; B25B 5/04

(52) U.S. Cl. CPC B25B 5/104; B25B 5/04

(57) ABSTRACT

A clamping device is provided, wherein the clamping device includes: a base including at least one connection portion; and a clamping mechanism including a lever, a rotatable rod rotatably connected to the base, a fixed jaw, a movable jaw, a movable member, a first connecting member and a second connecting member, the lever being rotatably inserted to the rotatable rod, the fixed jaw being connected to the base, the movable jaw being rotatably connected to the base so that the movable jaw and the fixed jaw are configured to clamp an object, the movable member being screwed to a threaded section of the lever, the first connecting member being connected to and movable with the movable member and the movable jaw, the second connecting member being connected to and movable with the movable member and the base.

### BACKGROUND OF THE INVENTION

### Field of the Invention

The present invention relates to a clamping device.

### Description of the Prior Art

Clamping devices are often used, in various fields such as woodworking, metal processing, assembly or daily life, to hold or secure objects to prevent them from moving or rotating, to stabilize them for carrying, processing and/or assembling.

However, generally speaking, a conventional clamping device has to be specific to correspond to the shape of the object to be clamped, which has very limited applicability. For example, it is very unstable to clamp a circular tube by two semicircular jaws each having a diameter which does not match the diameter of the circular tube. As such, the circular tube can wobble and rotates relative to the jaws easily.

The present invention is, therefore, arisen to obviate or at least mitigate the above-mentioned disadvantages.

### SUMMARY OF THE INVENTION

The main object of the present invention is to provide a clamping device which can stably clamp an object and is easy and quick to operate.

To achieve the above and other objects, a clamping device is provided, wherein the clamping device includes: a base including at least one connection portion, the at least one connection portion being configured to be positioned to a first object; and a clamping mechanism including a lever, a rotatable rod, a fixed jaw, a movable jaw, a movable member, a first connecting member and a second connecting member, the rotatable rod being connected to the base and rotatable about a first rotation axis, the lever being inserted to the rotatable rod and rotatable about a second rotation axis transverse to the first rotation axis, the fixed jaw being connected to the base, the movable jaw being rotatably connected to the base so that the movable jaw and the fixed jaw are configured to clamp a second object, the movable member being screwed to a threaded section of the lever, the first connecting member being connected to and movable with the movable member and the movable jaw, the second connecting member being connected to and movable with the movable member and the base.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a partial enlargement of FIG. 1;

FIG. 3 is a breakdown drawing of an exemplary embodiment of the present invention;

FIGS. 4 and 5 are drawings showing operation of a clamping device of an exemplary embodiment of the present invention;

FIG. 6 is a drawing showing application of the clamping device of an exemplary embodiment of the present invention;

FIG. 7 is a drawing showing the clamping device clamping a round object according to an exemplary embodiment of the present invention;

FIG. 8 is a drawing showing the clamping device clamping a rectangular object according to an exemplary embodiment of the present invention;

FIG. 9 is a breakdown drawing of a knob and a switch unit of an exemplary embodiment of the present invention;

FIG. 10 is a drawing showing the switch unit located in a first position according to an exemplary embodiment of the present invention; and

FIG. 11 is a drawing showing the switch unit located in a second position according to an exemplary embodiment of the present invention.

### DETAILED DESCRIPTION OF THE PREFERRED EMBODIMENTS

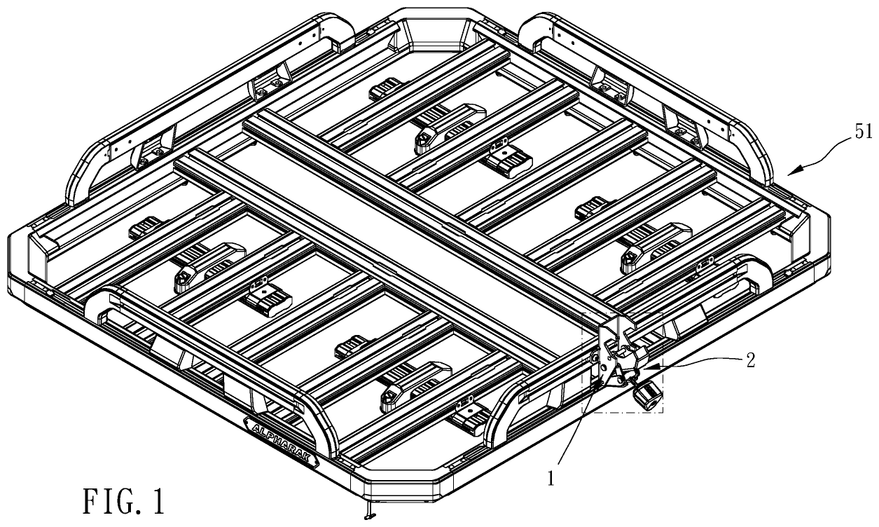

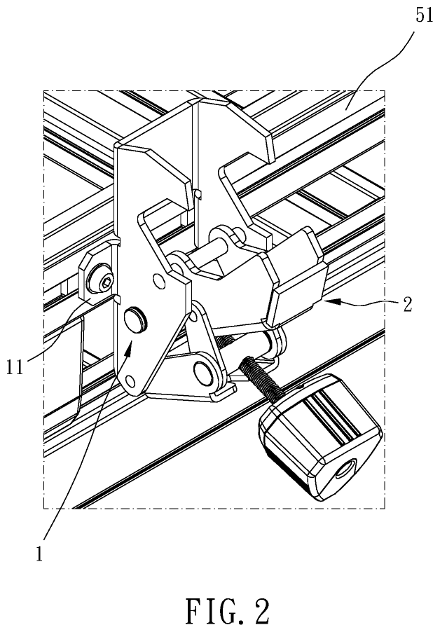

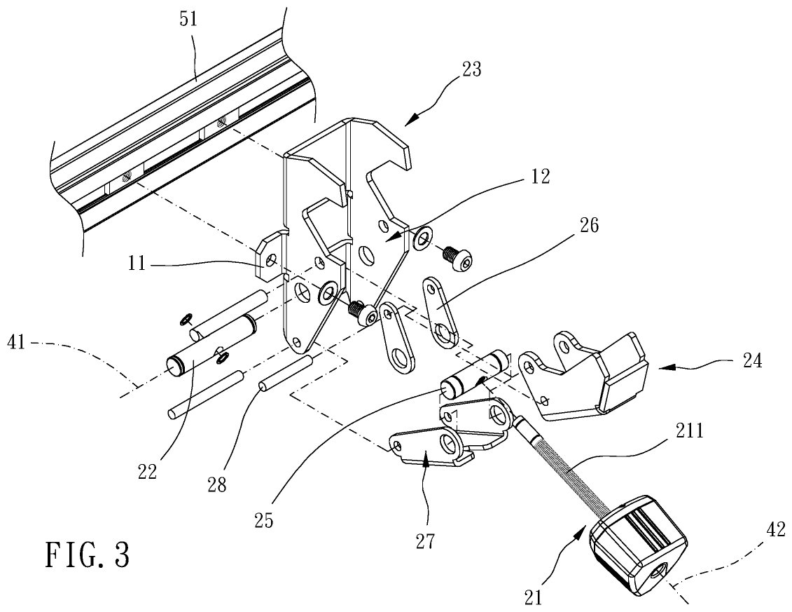

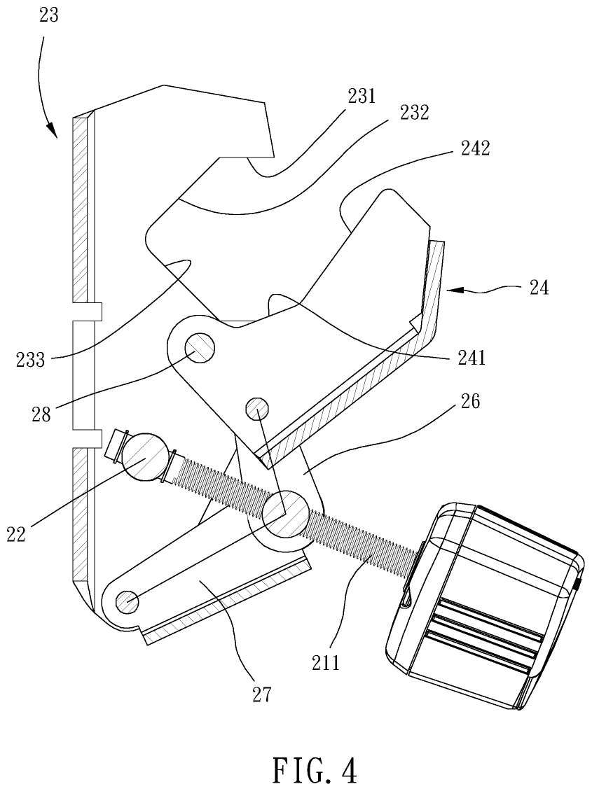

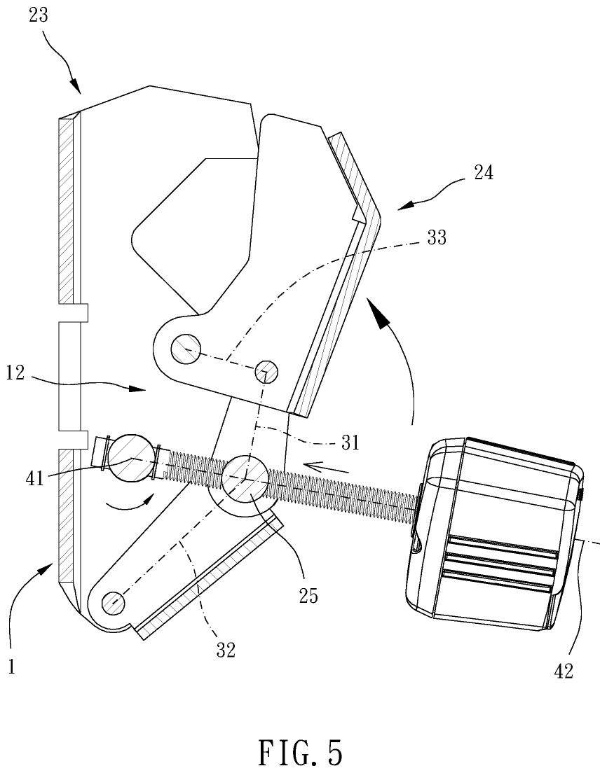

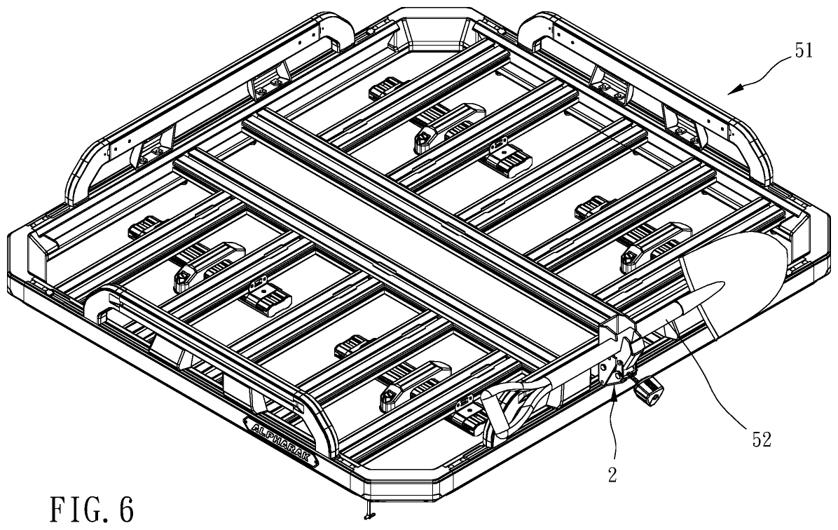

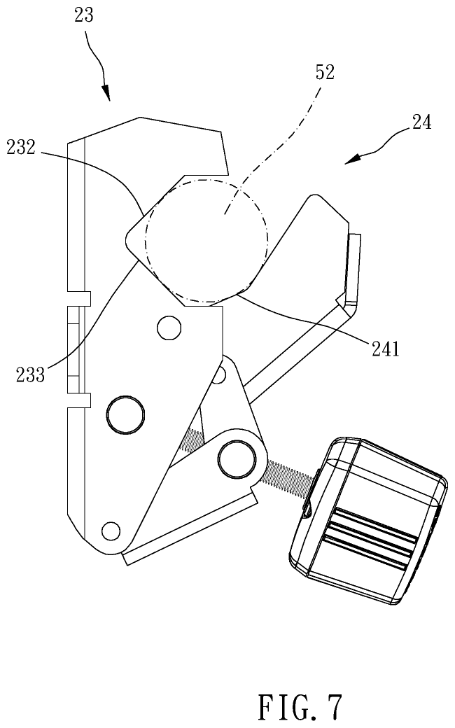

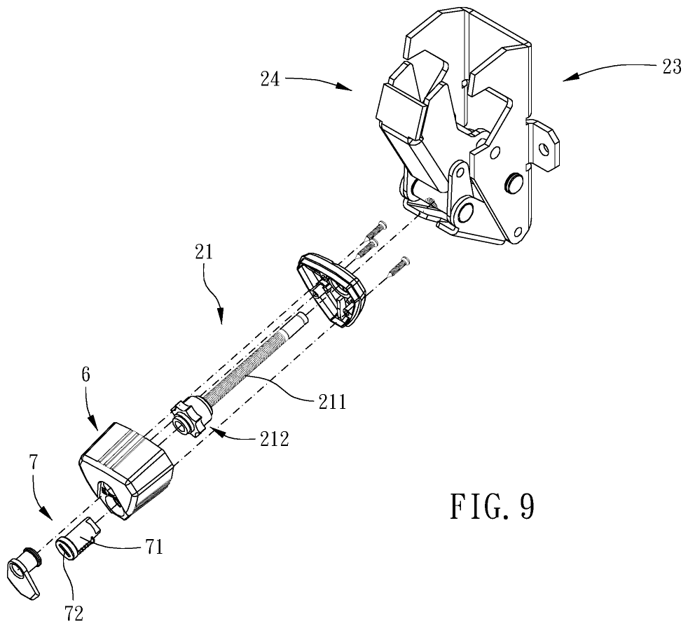

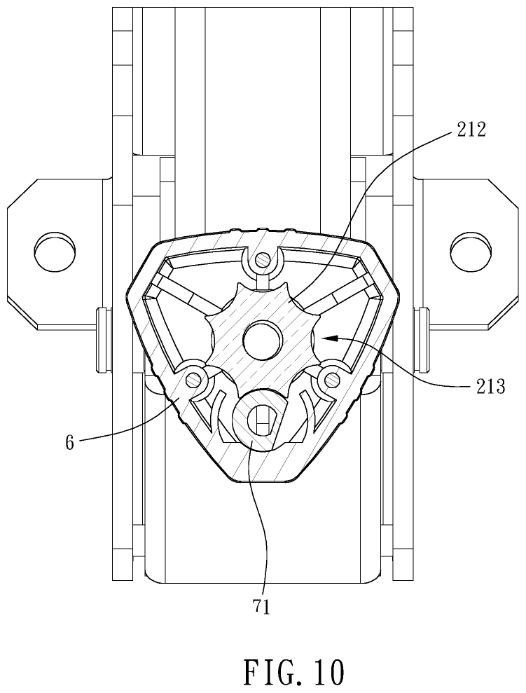

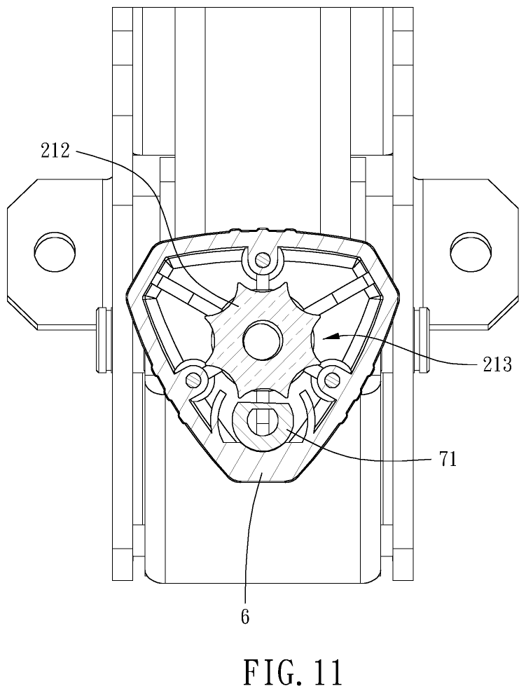

Please refer to FIGS. 1 to 11 for an exemplary embodiment of the present invention. A clamping device 1 of the present invention includes a base 1 and a clamping mechanism 2.

The base 1 includes at least one connection portion 11, and the at least one connection portion 11 is configured to be positioned to a first object 51. In this embodiment, the at least one connection portion 11 is a plate or a luggage rack having a threaded hole, and the first object 51 can be fixed to the plate, the rack or the like by a screw screwed to the threaded hole.

The clamping mechanism 2 includes a lever 21, a rotatable rod 22, a fixed jaw 23, a movable jaw 24, a movable member 25, a first connecting member 26 and a second connecting member 27. The rotatable rod 22 is connected to the base 1 and rotatable about a first rotation axis 41, the lever 21 inserted to the rotatable rod 22 and rotatable about a second rotation axis 42 transverse to the first rotation axis 41, the fixed jaw 23 is connected to the base 1, the movable jaw 24 is rotatably connected to the base 1 so that the movable jaw 24 and the fixed jaw 23 are configured to clamp a second object 52 (such as a shovel), the movable member 25 is screwed to a threaded section 211 of the lever 21, the first connecting member 26 is connected to and movable with the movable member 25 and the movable jaw 24, and the second connecting member 27 is connected to and movable with the movable member 25 and the base 1.

Preferably, the fixed jaw 23 and the base 1 is integrally formed of one piece, thus providing good structural strength and effectively simplifying assembly parts, saving assembly steps and total weight. In this embodiment, the base 1 and the fixed jaw 23 are formed from a same metal plate by bending.

In operation, the lever 21 rotates to drive the movable member 25 to move along the second rotation axis 42, the movable member 25 moves to drive the first connecting member 26 and the second connecting member 27 to swing relatively, and the rotatable rod 22 rotates to drive the movable jaw 24 to swing relative to the fixed jaw 23 to clamp.

The fixed jaw 23 includes a plurality of clamping surfaces, the movable jaw 24 includes a plurality of clamping surfaces, and the number of the plurality of clamping surfaces of the fixed jaw 23 is different from the number of the plurality of clamping surfaces of the movable jaw 24. With the clamping surfaces arranged in various angles and positions, the second object 52 can be abutted against in a variety of options, thus improving applicability. In this embodiment, when the clamping device is used to clamp on the second object 52 which is round, the second object 52, the fixed jaw 23 and the movable jaw 24 abut the second object 52 in three-point contact so that the second object 52 is effectively held and non-rotatable.

The fixed jaw 23 includes a first clamping surface 231, a second clamping surface 232 and a third clamping surface 233 which are connected with one another in sequence. An included angle between the first clamping surface 231 and the second clamping surface 232 is equal to or larger than 90 degrees, and an included angle between the second clamping surface 232 and the third clamping surface 233 is equal to or less than 90 degrees, for receiving the second object 52. The first clamping surface 231 is located on a side of the fixed jaw 23 remote from the base 1. In this embodiment, the included angle between the second clamping surface 232 and the first clamping surface 231 is an obtuse angle, and the included angle between the second clamping surface 232 and the third clamping surface 233 is 90 degrees. As viewed in an axial direction of the rotatable rod 22, the second clamping surface 232 has a length larger than a length of the first clamping surface 231.

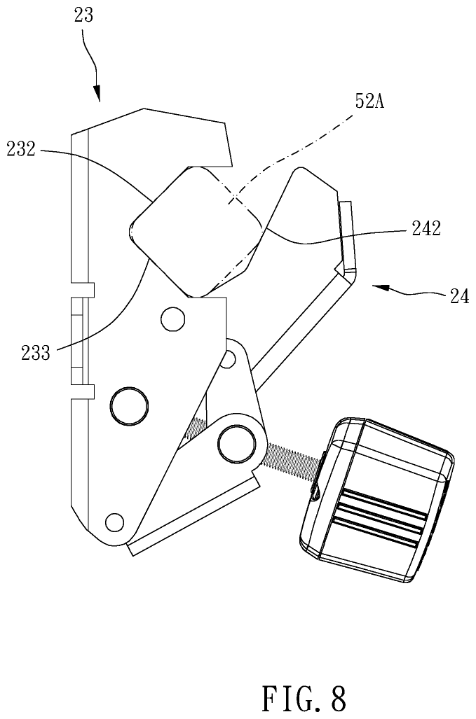

The fixed jaw 23 provides a space for receiving the second object 52, and the movable jaw 24 is used to hold the second object 52 stably. Specifically, the movable jaw 24 includes a fourth clamping surface 241 and a fifth clamping surface 242, and an included angle between the fourth clamping surface 241 and fifth clamping surface 242 is an obtuse angle, which is capable of pressing the second object 52 well. In this embodiment, the included angle between the fourth clamping surface 241 and fifth clamping surface 242 is larger than the included angle between the first clamping surface 231 and the second clamping surface 232. As viewed in the axial direction of the rotatable rod 22, the fifth clamping surface 242 has a length larger than a length of the fourth clamping surface 241, thus allowing the movable jaw 24 to be located in various angular positions, and allowing the fifth clamping surface 242 to move toward the second object 52 as close as possible. As a result, the fixed jaw 23 and the movable jaw 24 can be used to clamp not only the second object 52 which is round but also a second object 52A which is in any of different shapes (such as rectangle one shown in FIG. 8).

A distance from a pivot point of the first connecting member 26 and the movable jaw 24 to a pivot point of the first connecting member 26 and the movable member 25 is defined as a first distance 31, a distance from a pivot point of the second connecting member 27 and the movable member 25 to a pivot point of the second connecting member 27 and the base 1 is defined as a second distance 32, and a distance from a pivot point of the first connecting member 26 and the movable jaw 24 to a pivot point of the movable jaw 24 and the base 1 is defined as a third distance 33. The second distance 32 is larger than the first distance 31, which provides a large range of movement of the movable member 25; and the first distance 31 is larger than the third distance 33, which provides a large range of swinging of the movable jaw 24.

The base 1 further includes an internal space 12 which is open, the rotatable rod 22 is received in the internal space 12, and the movable jaw 24 is partially within the internal space 12. The clamping mechanism 2 further includes a shaft 28, in the internal space 12 the shaft 28 is inserted in the movable jaw 24 in a direction parallel to the first rotation axis 41 to position the base 1, and the movable jaw 24 is rotatable about the shaft 28. The shaft 28 has a diametric dimension smaller than a diametric dimension of the rotatable rod 22.

The clamping mechanism 2 further includes a knob 6 and a switch unit 7, the knob 6 is rotatably disposed around a head portion 212 of the lever 21, and the switch unit 7 is disposed on the knob 6. When the switch unit 7 is located in a first position, the switch unit 7 and the head portion 212 are blockable with each other in a direction in which the knob 6 rotates so that the knob 6 and the lever 21 are rotatable with each other. When the switch unit 7 is located in a second position, the switch unit 7 and the head portion 212 are free of being blockable with each other in the direction in which the knob 6 rotates so that the knob 6 and the lever 21 are rotatable relative to each other.

Preferably, the switch unit 7 includes a lock core 71 and a key hole 72, the lock core 71 is rotatably inserted in the knob 6, and the head portion 212 includes a plurality of recesses 213 arranged circumferentially. When the switch unit 7 is located in the first position, the lock core 71 is partially engaged within one of the plurality of recesses 213. When the switch unit 7 is located in the second position, the lock core 71 is disengaged from any of the plurality of recesses, and the clamping device cannot be operated until a key is inserted in the key hole 72 to activate the switch unit 7.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A clamping device including:
a base including at least one connection portion, the at least one connection portion being configured to be positioned to a first object; and
a clamping mechanism including a lever, a rotatable rod, a fixed jaw, a movable jaw, a movable member, a first connecting member and a second connecting member, the rotatable rod being connected to the base and rotatable about a first rotation axis, the lever being inserted to the rotatable rod and rotatable about a second rotation axis transverse to the first rotation axis, the fixed jaw being connected to the base, the movable jaw being rotatably connected to the base so that the movable jaw and the fixed jaw are configured to clamp a second object, the movable member being screwed to a threaded section of the lever, the first connecting member being connected to and movable with the movable member and the movable jaw, the second connecting member being connected to and movable with the movable member and the base.

2. The clamping device of claim 1, wherein the clamping mechanism further includes a knob and a switch unit, the knob is rotatably disposed around a head portion of the lever, the switch unit is disposed on the knob, when the switch unit is located in a first position, the switch unit and the head portion are blockable with each other in a direction in which the knob rotates so that the knob and the lever are rotatable with each other, and when the switch unit is located in a second position, the switch unit and the head portion are free of being blockable with each other in the direction in which the knob rotates so that the knob and the lever are rotatable relative to each other.

3. The clamping device of claim 1, wherein the fixed jaw includes a first clamping surface, a second clamping surface and a third clamping surface which are connected with one another in sequence, an included angle between the first clamping surface and the second clamping surface is equal to or larger than 90 degrees, an included angle between the second clamping surface and the third clamping surface equal to or less than 90 degrees, and the first clamping surface is located on a side of the fixed jaw remote from the base.

4. The clamping device of claim 3, wherein the included angle between the second clamping surface and the first clamping surface is an obtuse angle, and the included angle between the second clamping surface and the third clamping surface is 90 degrees.

5. The clamping device of claim 3, wherein the movable jaw further includes a fourth clamping surface and a fifth clamping surface, and an included angle between the fourth clamping surface and fifth clamping surface is an obtuse angle.

6. The clamping device of claim 5, wherein the included angle between the fourth clamping surface and fifth clamping surface is larger than the included angle between the first clamping surface and the second clamping surface.

7. The clamping device of claim 1, wherein a distance from a pivot point of the first connecting member and the movable jaw to a pivot point of the first connecting member and the movable member is defined as a first distance, a distance from a pivot point of the second connecting member and the movable member to a pivot point of the second connecting member and the base is defined as a second distance, a distance from a pivot point of the first connecting member and the movable jaw to a pivot point of the movable jaw and the base is defined as a third distance, the second distance is larger than the first distance, and the first distance is larger than the third distance.

8. The clamping device of claim 1, wherein the base further includes an internal space which is open, the rotatable rod is received in the internal space, the movable jaw is partially within the internal space, the clamping mechanism further includes a shaft, in the internal space the shaft is inserted in the movable jaw in a direction parallel to the first rotation axis to position the base, and the movable jaw is rotatable about the shaft.

9. The clamping device of claim 1, wherein the fixed jaw includes a plurality of clamping surfaces, the movable jaw includes a plurality of clamping surfaces, and the number of the plurality of clamping surfaces of the fixed jaw is different from the number of the plurality of clamping surfaces of the movable jaw.

10. The clamping device of claim 6, wherein the clamping mechanism further includes a knob and a switch unit, the knob is rotatably disposed around a head portion of the lever, the switch unit is disposed on the knob, when the switch unit is located in a first position, the switch unit and the head portion are blockable with each other in a direction in which the knob rotates so that the knob and the lever are rotatable with each other, and when the switch unit is located in a second position, the switch unit and the head portion are free of being blockable with each other in the direction in which the knob rotates so that the knob and the lever are rotatable relative to each other; the fixed jaw and the base is integrally formed of one piece; the included angle between the second clamping surface and the first clamping surface is an obtuse angle, and the included angle between the second clamping surface and the third clamping surface is 90 degrees; a distance from a pivot point of the first connecting member and the movable jaw to a pivot point of the first connecting member and the movable member is defined as a first distance, a distance from a pivot point of the second connecting member and the movable member to a pivot point of the second connecting member and the base is defined as a second distance, a distance from a pivot point of the first connecting member and the movable jaw to a pivot point of the movable jaw and the base is defined as a third distance, the second distance is larger than the first distance, and the first distance is larger than the third distance; the base further includes an internal space which is open, the rotatable rod is received in the internal space, the movable jaw is partially within the internal space, the clamping mechanism further includes a shaft, in the internal space the shaft is inserted in the movable jaw in a direction parallel to the first rotation axis to position the base, and the movable jaw is rotatable about the shaft; the fixed jaw includes a plurality of clamping surfaces, the movable jaw includes a plurality of clamping surfaces, and the number of the plurality of clamping surfaces of the fixed jaw is different from the number of the plurality of clamping surfaces of the movable jaw; the base and the fixed jaw are formed from a same metal plate by bending; as viewed in an axial direction of the rotatable rod, the second clamping surface has a length larger than a length of the first clamping surface, the fifth clamping surface has a length larger than a length of the fourth clamping surface; the shaft has a diametric dimension smaller than a diametric dimension of the rotatable rod; the first object is a luggage rack; the switch unit includes a lock core and a key hole, the lock core is rotatably inserted in the knob, the head portion includes a plurality of recesses arranged circumferentially, when the switch unit is located in the first position, the lock core is partially engaged within one of the plurality of recesses, and when the switch unit is located in the second position, the lock core is disengaged from any of the plurality of recesses.
